(19) United States
(12) Patent Application Publication
(10) Pub. No.: US 2004/0229573 A1
(43) Pub. Date: Nov. 18, 2004

(54) Amplification device with shared amplification stage for transmission and reception

(76) Inventors: Gunter Krasser, Graz (AT); Thomas Niederfriniger, Villach (AT)

Correspondence Address: Scott B. Stahl, Jackson Walker L.L.P., Suite 600, 2435 N. Central Expressway, Richardson, TX, 75080, US

(21) Appl. No.: 10/803,559

(22) Filed: Mar. 18, 2004

(30) Foreign Application Priority Data
Mar. 20, 2003 (DE) 103 12 435.7

(51) Int. Cl. H04B 1/38

(52) U.S. Cl. 455/73

(57) ABSTRACT

A circuit arrangement includes respective amplification devices for transmitting and receiving signals, with each amplification device having more than one amplification stage for the signal to be transmitted or received. An antenna can be connected to the amplification devices. At least one of the amplification stages is jointly used by the two amplification devices.

### FIELD OF THE INVENTION

The invention relates to a circuit arrangement for coupling a respective amplification device for transmission and reception.

### BACKGROUND OF THE INVENTION

Conventional transceiver systems in which the transmission and reception paths are integrated in a chip additionally have an antenna which is connected both to the transmission path and to the reception path.

FIG. 3 shows an example of this type. A switch RX/TX is provided therein between the antenna and the transceiver system (comprising the two signal paths) in order to connect either the transmission path TX or the reception path RX to the antenna. The respective other path is simultaneously disconnected from the antenna. This prevents, for example, a signal which comes from the transmission path and is to be transmitted from being injected into the reception path.

A signal which is to be transmitted is amplified in a power amplifier PA and then passes through a matching network in order to match the load impedance of the power amplifier PA and the input impedance of the antenna and switch RX/TX to one another. A signal received by the antenna passes via the reception path to a matching network and from there to a (low-noise) amplifier LNA which amplifies the received signal in order to then forward it for further processing. The two matching networks in the transmission and reception paths may be of different two matching networks in the transmission and reception paths may be of different design in order to compensate for the different output impedances of the two amplification devices. In this embodiment, the individual matching networks, the switch and the antenna are in the form of external components.

The arrangement described in FIG. 3 occupies a large amount of space and is costly owing to the additional complexity of the required components.

An object of the invention is therefore to provide an arrangement having lower system costs.

### SUMMARY OF THE INVENTION

Exemplary embodiments make it possible to dispense with a switch between the transmission and reception paths and to dispense with a matching network. The switch and matching network are dispensed with as a result of the fact that an amplification device comprising a plurality of amplification stages for transmission and an amplification device comprising a plurality of amplification stages for reception are arranged in such a manner that at least part of one of the amplification stages can be jointly used by the two amplification devices.

Matching the reception input impedance of the jointly used amplification stage to the load impedance during transmission of a signal makes it possible to omit a matching network, and a switch is advantageously part of the joint amplification stage. Lower attenuation within the jointly used signal path is additionally achieved.

One advantageous refinement is for the joint amplification stage to be a symmetrical MOS transistor.

### BRIEF DESCRIPTION OF THE DRAWINGS

The invention is explained in detail below using exemplary embodiments and with reference to the figures, in which:

FIG. 1 shows a circuit arrangement according to the invention,

FIG. 2 shows exemplary embodiments of the invention, and

FIG. 3 shows a known transmission and reception unit.

### DETAILED DESCRIPTION

Reference symbols in the drawings are:

(1, 2, 3): MOS transistor

(4,5): Biasing device

(Rx1, Rx2, Rx3): Switch

(Tx1, Tx2): Switch

(V_{DLNA}, V_{DPA}): Supply voltage

(V_{BLNA}): Biasing device

(V_{BPA}): Voltage supply

(L): Coil

(C): Capacitor

(A): Antenna

(RL): Load resistor

(AP): Matching network

(Tx): Transmission path

(Rx): Reception path

(Rx/Tx): Switch

(LNA): Amplifier

(PA): Power amplifier

(LNA_{OUT}): Output signal

(LNA_Main, LNA_Casc): Amplification stages

(OUTPUT TANK): Tuned circuit

(PA Biasing): Switch

(LNA Biasing): Switch

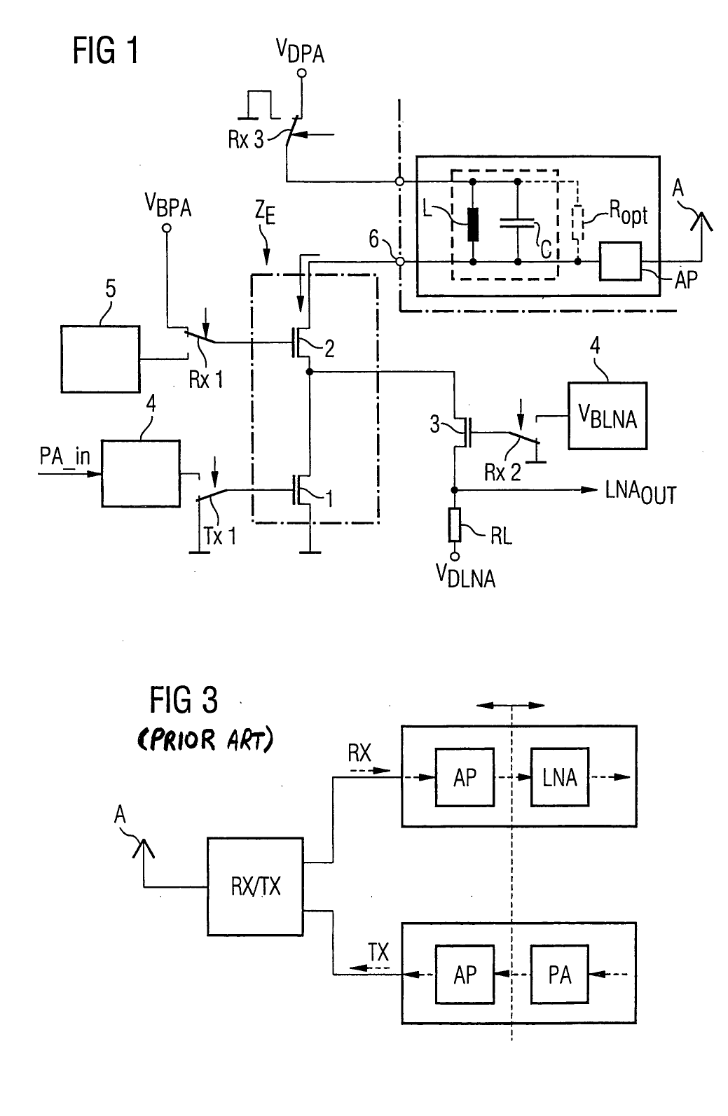

FIG. 1 shows a block diagram of an amplification device for transmission and reception, in which the amplification stages are in the form of MOS transistors. In this example, the amplification devices each comprise two amplification stages, with one amplification stage being jointly used by the two amplification devices. An MOS transistor 1 is connected, via its drain contact, to a second MOS transistor 2 and, by its source contact, to ground. The gate connection of the transistor 1 is connected, via a switch Tx1, to an amplifier and biasing device 4. The gate contact of the transistor 2 may be connected, via a switch Rx1, either to a voltage supply V_{BPA} or to a biasing device 5.

An MOS transistor 3, whose gate may be connected to a biasing device V_{BLNA} via a switch Rx2, is connected, by its drain contact, to a voltage V_{DLNA} via a load resistor RL and is connected, by its source connection, between transistor 2 and transistor 1. A signal LNA_{OUT} is tapped off between transistor 3 and the load resistor RL.

The other side of the transistor 2 leads to an external matching network which has a tuned circuit comprising a coil L and a capacitor C. The second input of the tuned circuit leads to a switch Rx3 which makes it possible to choose between the voltage V_{DPA} and ground potential. In parallel therewith, this output of the transistor 2 is connected to a matching circuit AP or antenna A. The symmetrical MOS transistor 2 is in the form of a joint power stage of the amplification device for transmission and reception.

When a signal is amplified using the arrangement and is transmitted via the antenna, the switch Tx1 is connected to device 4 and the switch Rx2 is connected to ground potential. By means of the switch Rx1, the gate of the MOS transistor 2 is at the potential V_{BPA}. The switch Rx3 makes the connection to the voltage source V_{DPA}. The signal to be amplified is applied to the gate connection of the transistor 1 via the device 4. The transistor 2 which acts as a cascode transistor during transmission advantageously splits the voltage at point 6 between the transistors 2 and 1. The result of this is not only that optimum efficiency of the power transistor 1 is achieved but also that the maximum permissible gate oxide loading of the transistor 1 is not exceeded when the voltage at point 6 changes from 0 to 2*V_{DPA}.

In the reception mode, the RF signals flow through the transistor 2 in the opposite direction, and the source and drain connections are interchanged.

For the purpose of receiving data, the switch Tx1 is connected to ground potential, the switch Rx2 is connected to the biasing device V_{BLNA}, the switch Rx3 is connected to ground potential and the gate connection of the transistor 2 is connected to the biasing device 5 via the switch Rx1. Transistor 2 is now the amplification element for a received signal coming from the antenna, and transistor 3 is the associated cascode transistor. The drain voltage V_{DLNA} is set to an optimum setting for signal reception. The received signal which has been amplified may be tapped off via the output LNA_{OUT}.

The switches Tx1 and Rx2 switch the transistors associated with them on and off without any power consumption via the respective gate connections and thus act as changeover switches for the transmission and reception paths. However, they are advantageously arranged outside the signal path and thus do not lead to undesired attenuation and to additional measures for impedance matching.

Another refinement of the invention is for the amplification stages of the transistors 1 and 3 to be bipolar transistors.

It is furthermore advantageous if the input impedance Z_{E} of the transistor 2 in reception mode is matched to an output impedance R_{OPT} in transmission mode in such a manner that optimum matching is achieved. The two supply voltages V_{DPA} and V_{DLNA} which are required for transmission and reception operation are optimized with respect to the respective requirements.

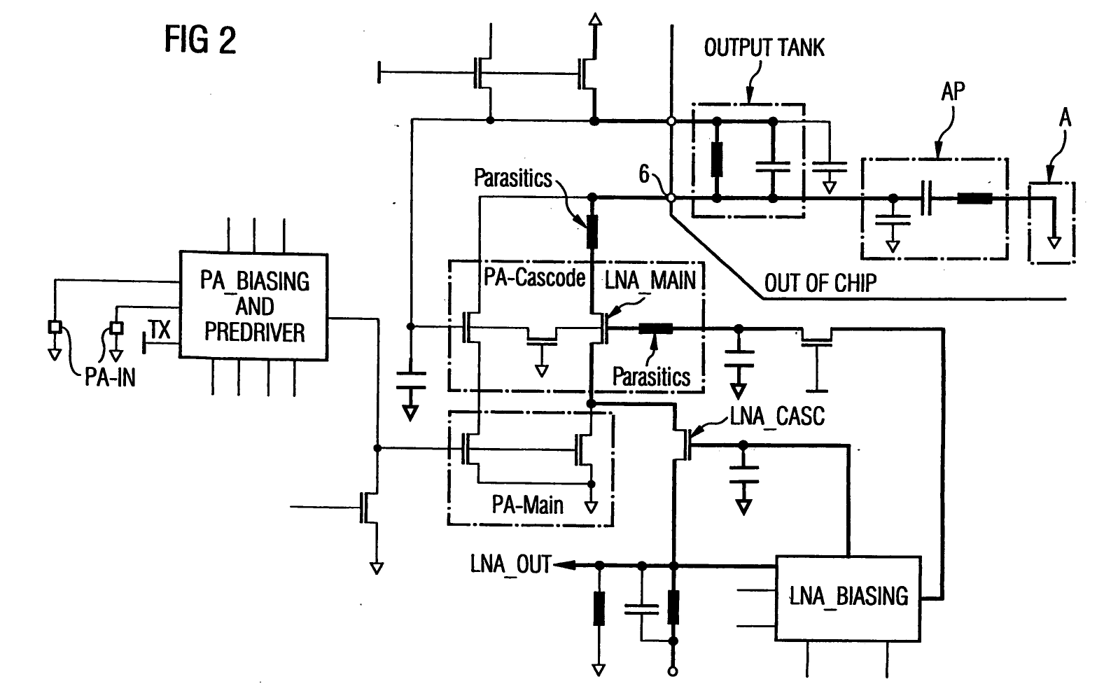

FIG. 2 shows an implementation example of the invention. The arrangement contains two amplification devices for transmission and reception, which each comprise two amplification stages. The amplification device for transmission contains the amplification stages designated PA-Main and PA-Cascode, while the amplification stages LNA_Main and LNA_Casc are used for reception. The transistor LNA_MAIN is part of both the reception device and the transmission device. The parasitic inductances and capacitances designated “PARASITICS” are taken into account when dimensioning and matching the impedance of the circuit. The region “OUT OF CHIP” situated outside the integrated circuit has a tuned circuit “OUTPUT TANK” and the network which is required for matching the impedance to the antenna. The devices “PA BIASING” and “LNA_BIASING” contain the necessary switches for transmission and reception operation.

The line sections indicated by thicker lines define an RF signal path in reception mode. The transistors used for amplification are in the form of MOSFET transistors.

Although exemplary embodiments of the invention are described above in detail, this does not limit the scope of the invention, which can be practiced in a variety of embodiments.

What is claimed is:

1. A circuit for communicating signals, comprising:
a transmit amplification device for transmitting signals, the transmit amplification device including more than one amplification stage;
a receive amplification device for receiving signals, the receive amplification device including more than one amplification stage; and
an antenna connected to the amplification devices;
wherein the amplification devices both include in common one of the amplification stages as a joint amplification stage.

2. The circuit of claim 1, wherein the joint amplification stage includes a symmetrical MOS transistor.

3. The circuit of claim 2, wherein each of the amplification devices includes first and second said amplification stages, the first and second amplification stages of the transmit device operationally corresponding to the first and second amplification stages of the receive device, respectively, and wherein the joint amplification stage is the first amplification stage of the receive amplification device and is also the second amplification stage of the transmit amplification device.

4. The circuit of claim 3, including a first switching device connected to one of the amplification stages of the transmit amplification device other than the joint amplification stage for switching off the transmit amplification device while the receive amplification device is receiving signals, and a second switching device connected to one of the amplification stages of the receive amplification device other than the joint amplification stage for switching off the receive amplification device while the transmit amplification device is transmitting signals.

5. The circuit of claim 4, wherein the receive amplification device has an input impedance that is matched to a load impedance of the transmit amplification device.

6. The circuit of claim 3, wherein the receive amplification device has an input impedance that is matched to a load impedance of the transmit amplification device.

7. The circuit of claim 2, including a first switching device connected to one of the amplification stages of the transmit amplification device other than the joint amplification stage for switching off the transmit amplification device while the receive amplification device is receiving signals, and a second switching device connected to one of the amplification stages of the receive amplification device other than the joint amplification stage for switching off the receive amplification device while the transmit amplification device is transmitting signals.

8. The circuit of claim 7, wherein the receive amplification device has an input impedance that is matched to a load impedance of the transmit amplification device.

9. The circuit of claim 2, wherein the receive amplification device has an input impedance that is matched to a load impedance of the transmit amplification device.

10. The circuit of claim 1, wherein each of the amplification devices includes first and second said amplification stages, the first and second amplification stages of the transmit device operationally corresponding to the first and second amplification stages of the receive device, respectively, and wherein the joint amplification stage is the first amplification stage of the receive amplification device and is also the second amplification stage of the transmit amplification device.

11. The circuit of claim 10, including a first switching device connected to one of the amplification stages of the transmit amplification device other than the joint amplification stage for switching off the transmit amplification device while the receive amplification device is receiving signals, and a second switching device connected to one of the amplification stages of the receive amplification device other than the joint amplification stage for switching off the receive amplification device while the transmit amplification device is transmitting signals.

12. The circuit of claim 11, wherein the receive amplification device has an input impedance that is matched to a load impedance of the transmit amplification device.

13. The circuit of claim 10, wherein the receive amplification device has an input impedance that is matched to a load impedance of the transmit amplification device.

14. The circuit of claim 1, including a first switching device connected to one of the amplification stages of the transmit amplification device other than the joint amplification stage for switching off the transmit amplification device while the receive amplification device is receiving signals, and a second switching device connected to one of the amplification stages of the receive amplification device other than the joint amplification stage for switching off the receive amplification device while the transmit amplification device is transmitting signals.

15. The circuit of claim 14, wherein the receive amplification device has an input impedance that is matched to a load impedance of the transmit amplification device.

16. The circuit of claim 1, wherein the receive amplification device has an input impedance that is matched to a load impedance of the transmit amplification device.
